(19) United States
(12) Patent Application Publication
(10) Pub. No.: US 2011/0169236 A1
(43) Pub. Date: Jul. 14, 2011

(54) SULKY FOR A FLOOR MAINTENANCE MACHINE AND METHODS OF STORAGE

(76) Inventor: Jeffery R. Fellhauer, Toledo, OH (US)

(21) Appl. No.: 13/004,187

(22) Filed: Jan. 11, 2011

Related U.S. Application Data
(60) Provisional application No. 61/335,812, filed on Jan. 11, 2010.

(51) Int. Cl. B62D 51/02; B23P 19/00; B23P 11/00

(52) U.S. Cl. 280/32.7; 29/426.1; 29/428

(57) ABSTRACT

A floor maintenance apparatus which allows an operator to ride in a standing position or walk behind the floor maintenance machine is described. The floor maintenance apparatus comprises a floor maintenance machine and a sulky. The sulky includes a first attaching portion. The sulky further includes an adjustable neck attached to the first attaching portion. The adjustable neck includes a first end portion and a second end portion. The sulky also includes a standing platform attached to the adjustable neck. The platform has a first portion and a second portion. At least one wheel is rotatably mounted to the first portion. Methods for storing the sulky are also provided.

### RELATED APPLICATION

This application is claiming the benefit, under 35 U.S.C. 119(e), of the provisional application which was granted Ser. No. 61/335,812 filed on Jan. 11, 2010 under 35 U.S.C. 111(b). This provisional application is hereby incorporated by reference.

### BACKGROUND OF THE INVENTION

Battery and plug-in floor maintenance machines are well known in the art. Some battery powered floor maintenance machines are provided with at least one rotatable pad, at least one front wheel, a battery compartment, a battery pack, at least one drive motor, a driven wheel, a steering column for allowing an operator to direct the machines' movements, and at least one rear wheel. Plug-in floor maintenance machines generally have similar components except for the battery pack and the battery compartment.

Regardless of whether the floor maintenance machine is battery powered or a plug-in, an operator will typically walking behind the machine to steer it. Requiring the operator to walk behind the machine can be extremely inefficient for several reasons. First, the maximum operating over the floor speed of the machine is usually greater than that of the operator walking behind it. Second, operator pace will vary by operator. Also, the operator's pace will generally be reduced as the operator gets tired. Finally, the reduction in the operator's pace will vary greatly from operator to operator. Thus, great deviation in the time needed to complete floor maintenance will exist between different operators using the same machine. Operating a floor maintenance machine in this manner is unpredictable, generally inefficient, and increasingly inefficient over time. It would be desirable then to provide an apparatus and a method for maintaining floors where the time needed to complete the job was predictable and limited only by the speed of the floor maintenance machine.

Some skilled in the art have recognized this and developed floor maintenance machines that can be operated so that the operator can sit or stand behind the machine while operating it. These inventions, however, greatly increase the footprint of the floor maintenance machine, which is undesirable especially when operating in small areas or for storage. Therefore, it would be advantageous to provide a sulky and methods for operating the floor maintenance machine which allow the operator to ride behind the floor maintenance machine and also reduce the footprint of the combination when the sulky is not being used.

### BRIEF SUMMARY OF THE INVENTION

The present invention is directed to a sulky for use with a floor maintenance machine. The sulky comprises a first attaching portion. In one embodiment, the sulky also comprises an adjustable neck attached to the first attaching portion. The adjustable neck comprises a first end portion and a second end portion. The sulky further comprises a standing platform attached to the adjustable neck. The standing platform has a first portion and a second portion. At least one wheel is rotatably mounted to the first portion.

Additionally, the present invention includes methods for storing a sulky.

In an embodiment, a method for storing a sulky comprises providing a floor maintenance apparatus. The floor maintenance apparatus comprises a floor maintenance machine and a sulky. The floor maintenance machine comprises a steering column. The floor maintenance machine and the sulky are connected so as to provide a standing platform perpendicular to the steering column for a floor maintenance machine operator to steer the floor maintenance machine. Also, the method comprises storing the sulky by selectively attaching the sulky to the floor maintenance machine so that the standing platform is unavailable to the floor maintenance machine operator for steering the floor maintenance machine.

In another embodiment, a method for storing a sulky attached to a floor maintenance machine is provided. The method comprises providing a sulky. The sulky comprises a first attaching portion and a standing platform. At least one wheel is rotatably mounted to the standing platform. The method also comprises connecting the sulky first attaching portion to a connecting portion attached to a floor maintenance machine so as to create a horizontal axis of rotation. Additionally, the method comprises lifting the sulky in a vertical direction along the horizontal axis of rotation.

### BRIEF DESCRIPTION OF THE SEVERAL VIEWS OF THE DRAWING

The above, as well as other advantages of the present invention, will become readily apparent to those skilled in the art from the following detailed description when considered in light of the accompanying drawings in which:

FIG. 1 is a perspective view of a floor maintenance apparatus;

FIG. 2 is a perspective view of a floor maintenance apparatus;

FIG. 3 is a top view of an embodiment of a sulky of the present invention;

FIG. 4 is a top view of the sulky of FIG. 3;

FIG. 5 is a side view of an embodiment of a sulky of the present invention;

FIG. 6 is a side view of the sulky of FIG. 5;

FIG. 7 is a perspective view of a floor maintenance apparatus;

FIG. 8 is a perspective view of a floor maintenance apparatus;

FIG. 9 is a perspective view of a floor maintenance apparatus;

FIG. 10 is a perspective view of a floor maintenance apparatus;

FIG. 11 is a top view of a floor maintenance apparatus;

FIG. 12 is a top view of a floor maintenance apparatus; and

FIG. 13 is a bottom view of a floor maintenance apparatus.

### DETAILED DESCRIPTION OF THE INVENTION

It is to be understood that the invention may assume various alternative orientations and step sequences, except where expressly specified to the contrary. It is also to be understood that the specific devices and methods illustrated in the attached drawings, and described in the following specification are simply exemplary embodiments of the inventive concepts defined in the appended claims. Hence, specific dimensions, directions, or other physical characteristics relating to the embodiments disclosed are not to be considered as limiting, unless the claims expressly state otherwise.

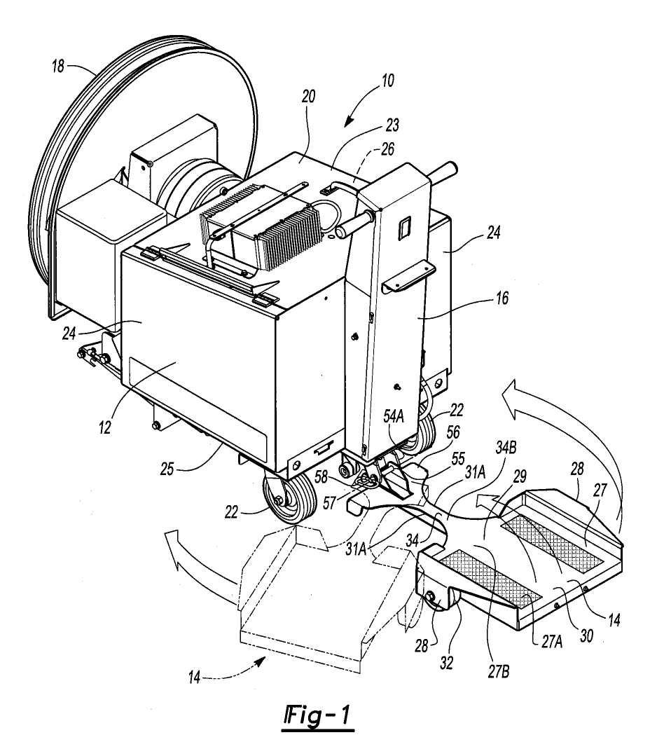

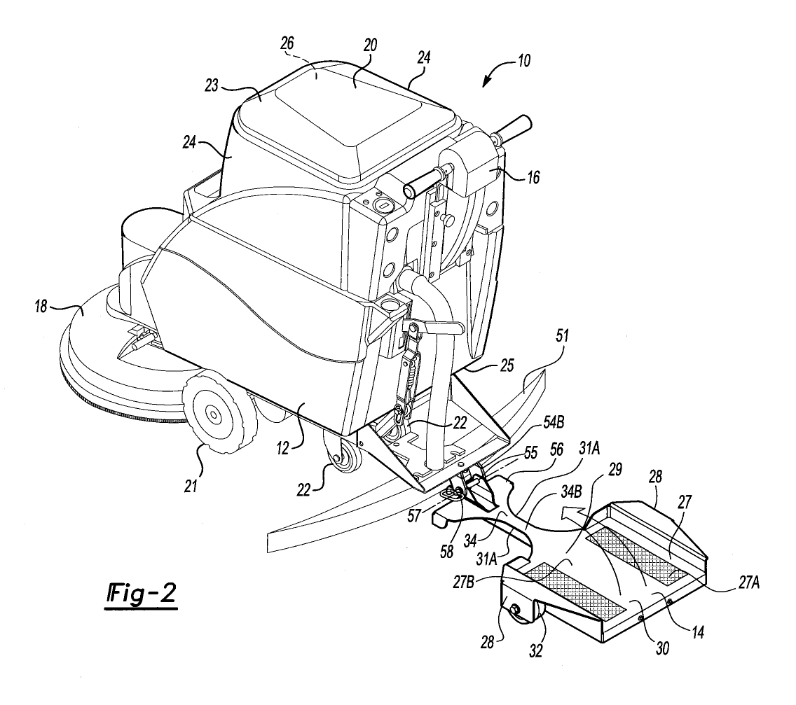

As shown in FIGS. 1 and 2, the present invention is generally practiced in connection with a floor maintenance apparatus 10. Generally, the floor maintenance apparatus 10 comprises a floor maintenance machine 12 and a sulky 14. In an embodiment, the floor maintenance machine 12 is self-propelled. In this embodiment, the floor maintenance machine 12 may be a battery powered burnisher. However, it should be understood that the sulky 14 described herein may be utilized with many other types of floor maintenance machines. Furthermore, it should be understood that the methods described herein may be utilized with many other types of floor maintenance machines compatible for use with a sulky.

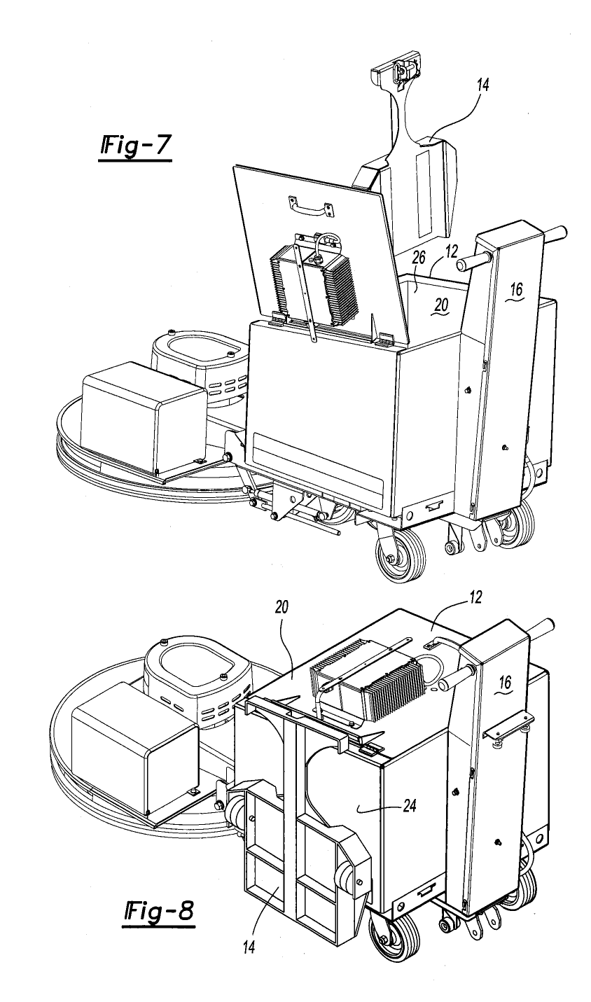

Preferably, the floor maintenance machine 12 comprises a steering column 16 for allowing a floor maintenance machine operator to steer the floor maintenance machine 12. The floor maintenance machine 12 may also comprise a rotatable pad 18, a battery compartment 20, a battery pack (not depicted) contained in the battery compartment 20, a drive motor (not depicted) for driving at least one front wheel 21 (see FIG. 2), and two rear wheels 22. The battery compartment 20 has an upper surface 23, sides 24, and a lower surface 25. The upper surface 23 is connected to the lower surface 25 by the sides 24 to form an enclosed space 26. As best shown in FIG. 7, the enclosed space 26 may be selectively enclosed.

The sulky 14 allows a floor maintenance machine operator to ride in a standing position, kneel, or walk behind the floor maintenance machine 12. The sulky 14 of the present invention comprises a standing platform 27. The standing platform 27 permits the operator to stand or kneel on the sulky 14, without having to walk behind the floor maintenance machine 12, while steering the machine 12.

Preferably, the standing platform 27 has a standing portion 27A, a first portion 29, and a second portion 30. The standing portion 27A is attached to the first portion 29 and the second portion 30. At least one wheel 32 is mounted to the standing platform 27, preferably in the standing platform first portion 29. Each wheel is preferably mounted in the first portion 29 adjacent the standing portion 27A. In an embodiment, the first portion 29 may be provided with a flange 28 for mounting a wheel 32 to the standing platform 27. Most preferably, two wheels 32 are rotatably mounted to separate flanges 28 on each side of the standing platform 27. However, as would be appreciated by one skilled in the art, any number of additional wheels or rollers are permissible in practicing the present invention.

When the at least one wheel 32 is mounted in the first portion 29 of the standing platform 27 and the floor maintenance machine operator stands in the standing portion 27A of the platform 27, the at least one wheel 32 acts as a fulcrum. In practice, a force is exerted by the weight of the operator when the operator stands on the standing platform 27 which counterbalances the force exerted by the floor maintenance machine on its rear wheels 22. This counterbalance upwardly biases a portion of the rearward weight of the floor maintenance machine 12 which in turn improves the overall maneuverability of the apparatus by allowing the rear wheels 22 to turn more freely.

The sulky 14 further comprises a neck 34. The neck 34 is attached to the standing platform 27. Preferably, the neck 34 is attached to first portion 29 of the standing platform 27 in a symmetrical manner. In an embodiment, the neck 34 has a surface 34B, 34C which is in a planar arrangement with a surface 27B, 27C of the standing platform 27. The neck 34 comprises a wheel receiving portion 31A, 31B. The wheel receiving portion 31A, 31B receives the rear wheels 22 of the floor maintenance machine 12.

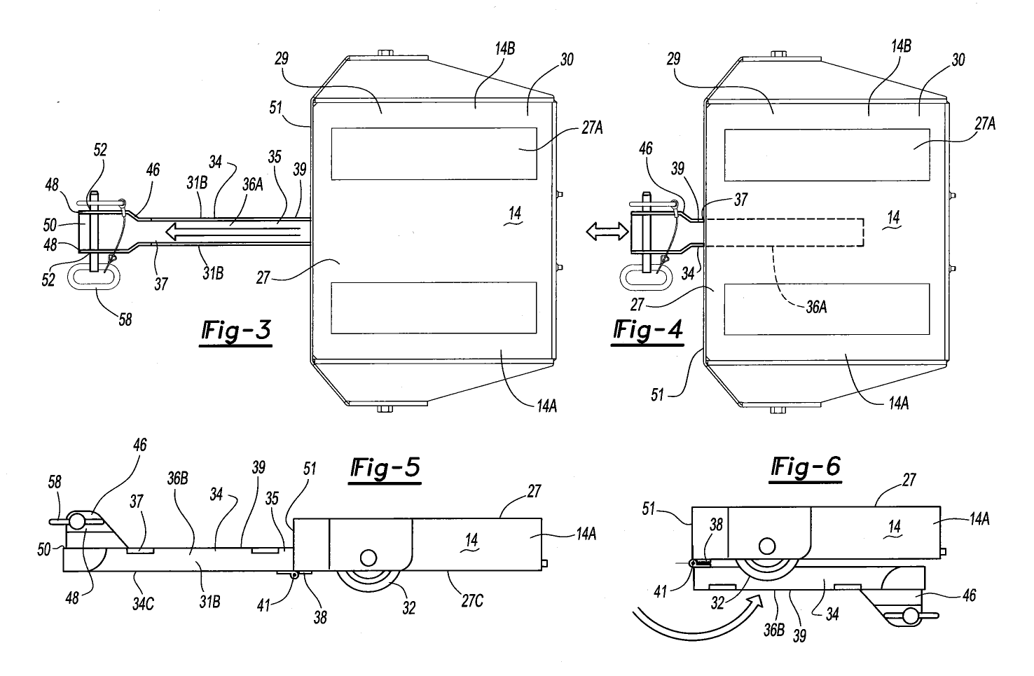

In embodiments depicted in FIGS. 3-6, the neck 34 is adjustable. The adjustable neck 39 comprises a first end portion 35 and a second end portion 37, and the wheel receiving portion 31B. The first end portion 35 is connected to the wheel receiving portion 31B which is connected to the second end portion 37. Preferably, the first end portion 35 is also attached to the standing platform 27. In an embodiment, the adjustable neck 29 is unitary.

The adjustable neck 39 also comprises an adjustable neck portion 36A, 36B. The adjustable neck portion 36A, 36B is connected to the first end portion 35 on an end and the second end portion 37 on an opposite end. As shown in FIGS. 3 and 4, the adjustable neck portion 36A may be telescopic. In this embodiment, the adjustable neck portion 36A may be a hollow cylinder or tube that can expand and/or collapse beneath the standing platform 27. Alternatively, the adjustable neck portion 36A can slide, without telescoping on itself, beneath the standing platform 27. FIGS. 5 and 6 depict an alternative embodiment. In this embodiment, the adjustable neck 39 may be attached to the standing platform 27 so that the adjustable neck portion 36B can pivot about at least one horizontal axis 41. Preferably, the at least one horizontal axis 41 is located between or proximate the standing platform 27 and the adjustable neck 39. In this embodiment, the first end portion 35 may be attached to the standing platform 27 by a hinge 38.

The sulky 14 also comprises a first attaching portion 46 attached to the neck 34. Preferably, the second end portion 37 of the neck 34 is attached to first attaching portion 46. The first attaching portion 46 may have two arms 48 that extend upward from a base 50. In an embodiment, each arm 48 has a hole 52 which corresponds to a hole in a connecting portion 54A, 54B of the floor maintenance machine 12.

An adjustable neck 39 can reduce the amount of space required by the sulky 14 for storage. As shown in FIG. 4, when the adjustable neck portion 36A is slid or collapsed beneath the standing platform 27, only the first end portion 37 and the first attaching portion 46 extend beyond the perimeter 51 of the standing platform 27. Whereas, when the adjustable neck 36B is pivoted beneath the standing platform as shown in FIG. 6, the entire adjustable neck 39 and the first attaching portion 46 are contained within the perimeter 51 of the standing platform 27. Thus, these embodiments both facilitate storage of the sulky 14 on and off the floor maintenance machine 12.

In an embodiment, the connecting portion 54A of the floor maintenance machine 12 is a swivel. A description of a swivel suitable for practice with the present invention can be found in U.S. application Ser. No. 12/288,811, the entire disclosure of which is hereby incorporated by reference. A swivel not only provides an attachment point 55, but it may also allow the sulky 14 to rotate 360° about a vertical axis when the floor maintenance machine 12 turns or is driven in a reverse direction.

However, under certain conditions it may be desirable to restrict or limit the rotation of the sulky 14 about the vertical axis. As shown in FIG. 1, this can be accomplished by providing the sulky with a stopping portion 56. The stopping portion 56 contacts the floor maintenance machine 12 to prevent excessive rotation of the sulky 14 about the vertical axis. The stopping portion 56 is attached to the neck 34, preferably adjacent the wheel receiving portion 31A, 31B.

In another embodiment, best shown in FIG. 2, it may be desirable to further reduce the risk that the sulky 14 will rotate excessively. Thus, in addition to providing the stopping portion 56, the connecting portion 54B of the floor maintenance machine 12 may be restricted from rotation. In this embodiment, the floor maintenance machine 12 may have, for example, a squeegee 51 positioned adjacent the rear of the machine 12 which could be damaged if the sulky 14 rotated and contacted it. Thus, the connecting portion 54B may provide an attachment point 55 but not a vertical axis of rotation.

The first attaching portion 46 may be selectively connected to the floor maintenance machine 12 by a removable attaching pin 58. The attaching pin 58 can be a cotter pin or a clevis pin. The attaching pin 58 can also be nut and a bolt, a lock weight pin, a push button lock weight pin, or any other removable attaching pin which when connecting the floor maintenance machine 12 with the sulky 14 creates a horizontal axis of rotation 57. The removable attaching pin 58 permits the sulky 14 to be shared between other floor maintenance machines and/or to be used with existing machines. It also allows the sulky 14 to be disconnected from the floor maintenance machine 12, allowing the machine 12 to be used without the sulky 14 attached or for easier storage of the machine 12 and/or the sulky 14.

The present invention also provides methods for storing a sulky 14.

In an embodiment, the method comprises providing a floor maintenance apparatus 10 comprising a floor maintenance machine 12 and a sulky 14. The floor maintenance machine comprises a steering column 16. Additionally, the floor maintenance machine 12 and the sulky 14 are connected so as to provide a standing platform 27 perpendicular to the steering column 16 for a floor maintenance machine operator to steer the machine 12. Further, the method comprises storing the sulky 14 by selectively attaching the sulky 14 to the floor maintenance machine 12 so that the standing platform 27 is unavailable to the floor maintenance machine operator for steering the floor maintenance machine 12.

Thus, the method may further comprise disconnecting the sulky 14 from the floor maintenance machine 12 prior to storage. For instance, as shown in FIG. 7, the sulky 14 may be disconnected from the floor maintenance machine 12 and at least a portion of the sulky 14 may be stored within the floor maintenance machine battery compartment 20. In a related embodiment, the sulky 14 may be stored within a compartment dedicated to the sulky that may be separate from the battery compartment 20.

In another embodiment, the sulky 14 may be stored outside the floor maintenance machine battery compartment 20. Therefore, in an embodiment, like the one depicted in FIG. 8, the sulky 14 may be disconnected from the floor maintenance machine 12 and at least a portion of the sulky 14 may be selectively attached to a side 24 of the machine's battery compartment 20. In this embodiment, the sulky 14 may be attached to the battery compartment 20 by hooks, rails, mechanical fasteners, clamps, baskets, tie down structures or the like.

As shown in FIG. 9, in another embodiment, the sulky 14 can be disconnected from the floor maintenance machine 12 and at least a portion of the sulky 14 may be selectively attached to the upper surface 23 of the machine's battery compartment 20 for storage perpendicular to the machine's steering column 16. The attachment may be as described above.

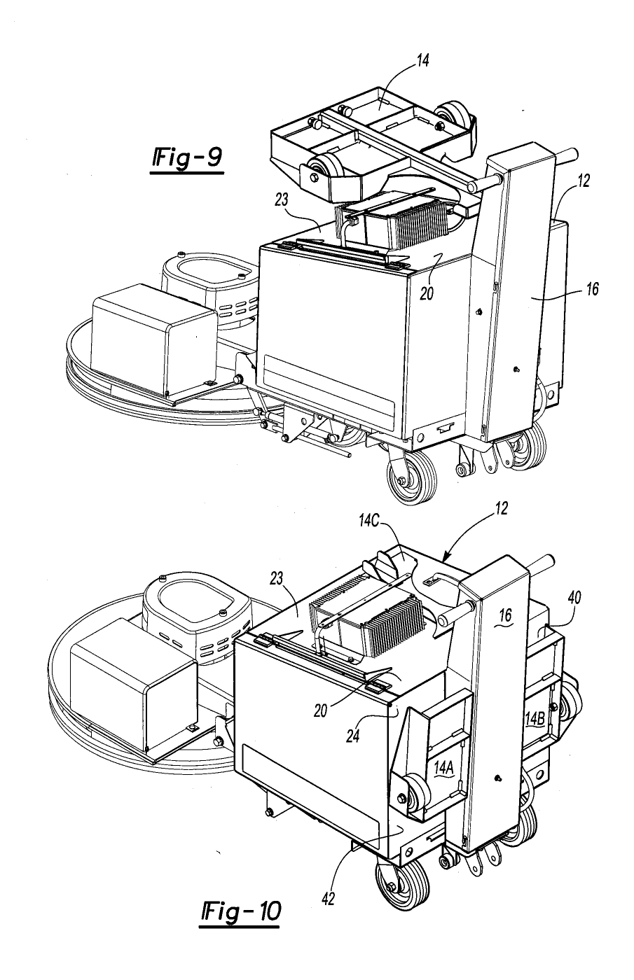

In an alternative embodiment, like the one shown in FIG. 10, the sulky 14 can be disconnected from the floor maintenance machine 12 and at least a portion of the sulky 14 may be selectively attached to the machine's battery compartment 20 for storage parallel to the machine's steering column 16. In a further embodiment, the sulky 14 can be disconnected from the floor maintenance machine 12 and divided into two or more sections 14A, 14B, 14C. The sections 14A, 14B, 14C may be attached to a battery compartment side 24 or surface 23, 25. In the depicted embodiment, two sections 14A, 14B are attached to either side 40, 42 of the floor maintenance machine's steering column 16 and the third section 14C is attached to the floor maintenance machine upper surface 23. The sections 14A, 14B, 14C may be attached as described above.

As depicted in FIGS. 3-6, the adjustable neck 39 may be slid or folded into or back onto one of the sections 14A, 14B and the sulky 14 may be stored by selectively attaching the sulky 14 to the floor maintenance machine 12 in accordance with any of the above-described embodiments. Alternatively, the neck 34 may be detached from the standing platform 27 and stored within the battery compartment 20 or on any of the battery compartment sides 24 or surfaces 23, 25.

Those skilled in the art would appreciate that it is within the scope of the present invention to store portions of the sulky 14 in alternative orientations on the surfaces 23, 25 and/or a side or sides 24 of the battery compartment 20. For instance, sections 14A, 14B, 14C of the sulky 20 could be attached to either surface 23, 25 or a side or sides 24 at angles which are not approximately 90° and 180° to the floor maintenance machine steering column 16.

In embodiments where at least a sulky section 14A, 14B, 14C is attached to the floor maintenance machine battery compartment 20 for storage, those skilled in the art would appreciate that attaching devices such as at least one hook (not depicted) or at least one clamp (not depicted) may be provided to secure a sulky section 14A, 14B, 14C A to the upper surface 23 or the outer surface 24 of the battery compartment 20. In other embodiments, where at least a sulky section 14A, 14B, 14C is attached to the battery compartment 20 for storage, a basket (not depicted) may be provided. In these embodiments, the basket is attached to a surface 23, 25 or a side or sides 24 of the battery compartment 20 and at least a section 14A, 14B, 14C of the sulky 14 is placed inside the basket. In still further embodiments, where at least a section 14A, 14B, 14C of the sulky 14 is attached to the floor maintenance machine battery compartment 20 for storage, the upper surface 23 or a side or sides 24 of the battery compartment 20 may be formed in a shape complimentary to a section 14A, 14B, 14C of the sulky 14. In these embodiments, the formed surface 23, 24 allows at least portions of the sulky 14 to be attached directly to the floor maintenance machine 12 for storage and prevent movement of the sulky sections 14A, 14B, 14C when the sulky 14 was not being utilized.

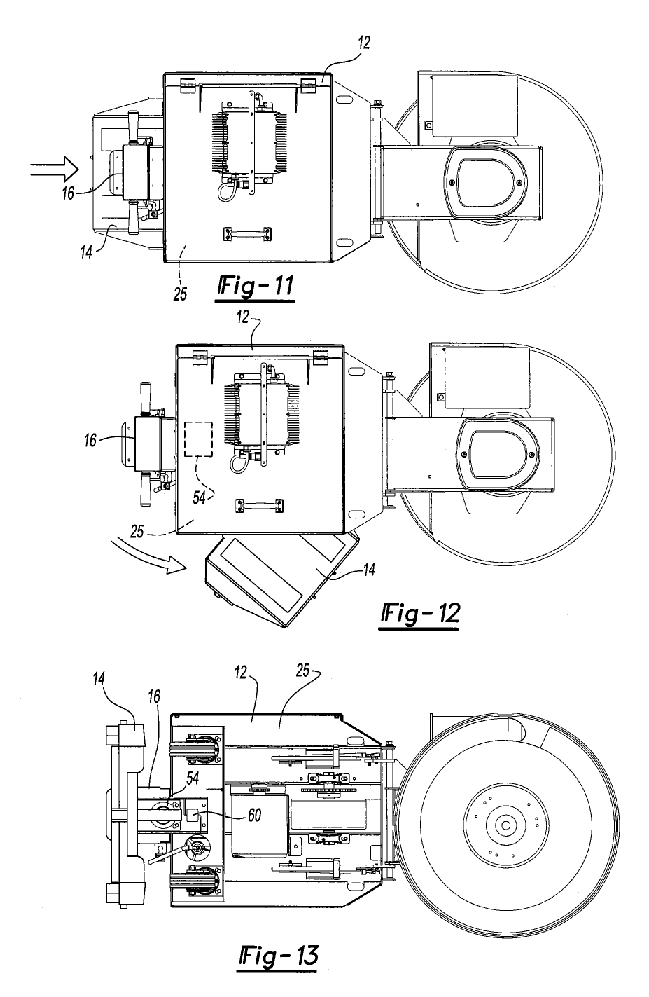

However, there are embodiments of the present invention where the sulky 14 need not be disconnected from the floor maintenance machine 12 for storage to obtain the same advantages. In an embodiment, the sulky 14 can be stored perpendicular to the floor maintenance machine steering column 16 by positioning the sulky 14 underneath the floor maintenance machine 12. For instance, as shown in FIG. 11, the sulky 14 may be slid underneath the floor maintenance machine 12 for storage. In this embodiment, a set of parallel rails (not depicted) may be attached to the floor maintenance machine battery compartment lower surface 25 for sliding and storing at least a section 14A, 14B, 14C of the sulky 14 beneath the floor maintenance machine 12. In another embodiment, like the one shown in FIG. 12, the sulky 14 may be rotated underneath the floor maintenance machine 12 for storage. The rotation may occur as a function of the connecting portion 54A or some other pivoting mechanism.

The present invention also provides a method for storing a sulky 14 attached to a floor maintenance machine 12. The method comprises providing the sulky 14, connecting the sulky first attaching portion 46 to the floor maintenance connecting portion 54A, 54B and lifting the sulky 14 in a vertical direction along the horizontal axis of rotation 57. The method may further comprise lowering the sulky 14 in a vertical direction along the same horizontal axis of rotation 57. One skilled in the art would appreciate that this method may be practiced manually by the floor maintenance machine operator or by another. However, as shown in FIG. 13, this embodiment may also include providing an electromechanical device 60 to lift and/or lower the sulky 14.

Additionally, the electromechanical device 60 may also be may be utilized to rotate a section 14A, 14B, 14C or the entire sulky 14 underneath the floor maintenance machine 12 for storage. Furthermore, one skilled in the art would appreciate that the electromechanical device 60 may be utilized to slide a section 14A, 14B, 14C or the entire sulky 14 underneath the floor maintenance machine 12 for storage.

The electromechanical device 60 may utilize fluid or pneumatic pressure and/or chains, pulleys, and an electric motor to perform these functions. The electromechanical device 60 is attached to both the sulky 14 and the floor maintenance machine 12. The electromechanical device 60 may be attached to any portion of the sulky 14. However, an advantageous location for attaching the electromechanical device 60 to the sulky 14 is the first attaching portion 46 or the stopping portion 56. Additionally, while the electromechanical device 60 may be attached to any portion of the floor maintenance machine 12, it is preferred that the electromechanical device 60 is attached to the lower surface 25.

Additionally, it should be noted that when the floor maintenance machine 12 is of the plug-in variety and a battery compartment 20 is not provided, the floor maintenance machine 12 may include a housing. The housing may have an upper surface, sides, and a lower surface. The upper surface may be connected to the lower surface by the sides in a manner similar to the upper surface 23, lower surface 25, and the sides 24 of the battery compartment 20. Therefore, the housing may be used in a manner similar to the battery compartment 20 for storing the sulky 14 in accordance with any of the above-described embodiments.

In accordance with the provisions of the patent statutes, the present invention has been disclosed in what are considered to represent its preferred embodiments. However, it should be noted that the invention can be practiced otherwise than as specifically illustrated and described without departing from its spirit or scope.

What is claimed is:

1. A sulky, comprising:
a first attaching portion;
an adjustable neck attached to said first attaching portion, wherein said adjustable neck comprises a first end portion and a second end portion; and
a standing platform attached to said adjustable neck, said platform having a first portion and a second portion wherein at least one wheel is rotatably mounted to said first portion.

2. The sulky defined in claim 1, wherein said adjustable neck further comprises an adjustable neck portion and is a hollow tube.

3. The sulky defined in claim 1, wherein said adjustable neck can pivot about at least one horizontal axis.

4. The sulky defined in claim 1, wherein said adjustable neck is connected to said standing platform by a hinge.

5. The sulky defined in claim 1, wherein said adjustable neck is telescopic.

6. A method for storing a sulky, comprising:
providing a floor maintenance apparatus comprising a floor maintenance machine and a sulky, said floor maintenance machine comprising a steering column, and wherein said floor maintenance machine and said sulky are connected so as to provide a standing platform perpendicular to said steering column for a floor maintenance machine operator to steer the floor maintenance machine; and
storing said sulky by selectively attaching said sulky to said floor maintenance machine so that said standing platform is unavailable to said floor maintenance machine operator for steering the floor maintenance machine.

7. The method defined in claim 6, further comprising disconnecting said sulky from said floor maintenance machine.

8. The method defined in claim 6, wherein at least a portion of said sulky is stored perpendicular to said floor maintenance machine steering column.

9. The method defined in claim 8, wherein at least a portion of said sulky is stored parallel to said floor maintenance machine steering column.

10. The method defined in claim 8, wherein at least a portion of said sulky is stored within said floor maintenance machine.

11. The method defined in claim 8, wherein said floor maintenance machine further comprises a battery compartment, said battery compartment having an upper surface, an outer surface, and a lower surface, said upper surface being connected to said lower surface by said outer surface to form a selectively enclosed space and wherein at least a portion of said sulky is stored within said enclosed space or on said upper surface of said battery compartment.

12. The method defined in claim 8, wherein said floor maintenance machine further comprises a battery compartment, said battery compartment having an upper surface, an outer surface, and a lower surface, said upper surface being connected to said lower surface by said outer surface to form a selectively enclosed space and wherein at least one hook is attached to said outer surface for storing at least a portion of said sulky.

13. The method defined in claim 8, further comprising positioning said sulky beneath said floor maintenance machine, wherein said floor maintenance machine further comprises a battery compartment, said battery compartment having an upper surface, an outer surface, and a lower surface, said upper surface being connected to said lower surface by said outer surface to form a selectively enclosed space.

14. A method for storing a sulky attached to a floor maintenance machine, comprising:
providing a sulky, said sulky comprising a first attaching portion and a standing platform, wherein at least one wheel is rotatably mounted to said standing platform;
connecting said sulky first attaching portion to a connecting portion attached to a floor maintenance machine so as to create a horizontal axis of rotation; and
lifting said sulky in a vertical direction along said horizontal axis of rotation.

15. The method defined in claim 14, further comprising lowering said sulky in a vertical direction.

16. The method defined in claim 14, wherein said lifting is performed by an electromechanical device.

17. The method defined in claim 14, wherein said lifting is performed by using a fluid or pneumatically.

18. The method defined in claim 16, wherein said floor maintenance machine has a lower surface and wherein said electromechanical device is attached to said floor maintenance machine on a lower surface.

19. The method defined in claim 16, wherein said electromechanical device may rotate or slide at least a section of said sulky underneath said floor maintenance machine.

20. The method defined in claim 18, wherein said electromechanical device is attached to either said sulky first attaching portion or a stopping portion.
